(19) United States
(12) Patent Application Publication
(10) Pub. No.: US 2022/0194863 A1
(43) Pub. Date: Jun. 23, 2022

(54) HYBRID WOVEN FIBER PREFORM-REINFORCED COMPOSITE MATERIAL AND PREPARATION METHOD THEREOF

(71) Applicant: NANJING UNIVERSITY OF AERONAUTICS AND ASTRONAUTICS, Nanjing Jinagsu (CN)

(72) Inventors: Zhaofeng CHEN, Nanjing Jinagsu (CN); Qiqiao XIAO, Nanjing Jinagsu (CN); Yunliang MIAO, Nanjing Jinagsu (CN)

(73) Assignee: NANJING UNIVERSITY OF AERONAUTICS AND ASTRONAUTICS, Nanjing, Jiangsu (CN)

(21) Appl. No.: 17/431,206

(22) PCT Filed: Jan. 5, 2021
(86) PCT No.: PCT/CN2021/070325

§ 371 Date: Aug. 16, 2021

(30) Foreign Application Priority Data
Jul. 9, 2020 (CN) 202010683522.1

(51) Int. Cl. C04B 35/80; C04B 35/565; C04B 35/622; C22C 49/14; C22C 47/12; C22C 47/06; C22C 47/04

(52) U.S. Cl. CPC C04B 35/80; C04B 35/565; C04B 35/62281; C04B 35/62245; C22C 49/14; C04B 2235/5244; C22C 47/06; C22C 47/04; C04B 2235/5232; C04B 2235/5224; C22C 47/12

(57) ABSTRACT

The present disclosure discloses a hybrid woven fiber preform-reinforced composite material, including a fiber preform, a composite material interface and a matrix, where the fiber preform is a three-dimensional fabric hybrid woven by 2-5 high-performance inorganic fibers, and the matrix is selected from the group consisting of resin, light alloy, carbon and ceramic. A preparation method of the composite material includes: preparing ceramic slurry, fiber bundle impregnation treatment, fiber weaving, molding of three-dimensional overall structure preform, preform heat treatment, preparing interface and preparing matrix. The present disclosure improves the weaving performance of inorganic rigid fibers, and the prepared hybrid woven fiber preform-reinforced composite material has desirable integrity, high interlayer bonding strength, and is not easy to layer. Meanwhile, the present disclosure realizes the functions of wave transmission, wave-absorbing, high-temperature structural material, thermal insulation and thermal prevention through the combination of hybrid woven fibers.

### CROSS REFERENCE TO RELATED APPLICATION

The present application claims priority to the Chinese Patent Application No. CN202010683522.1, filed with the China National Intellectual Property Administration (CNIPA) on Jul. 9, 2020, and entitled “HYBRID WOVEN FIBER PREFORM-REINFORCED COMPOSITE MATERIAL AND PREPARATION METHOD THEREOF”, which is incorporated herein by reference in its entirety.

### TECHNICAL FIELD

The present disclosure relates to a composite material and a preparation method thereof, and in particular to a hybrid woven fiber preform-reinforced composite material and a preparation method thereof.

### BACKGROUND ART

The continuous fiber has high performance and high strength, and composite materials reinforced by continuous fiber have such advantages as light weight, high strength and diversified functions. The continuous fiber is currently one of the materials with the most use potential. However, the use of the continuous fiber is limited due to the internal structure of composite materials and limited fiber types. Therefore, it is necessary to develop hybrid woven fiber preforms and composite materials with integrated structural strength and function through the structural design of fiber reinforcement for composite materials.

As a reinforced structure of the composite materials, the fiber preform has its external load transmitted to the fiber through the matrix. The fiber preform is an important guarantee for the structural strength of the composite materials. Under traditional conditions, the fiber preform includes a single type of fiber, which usually has the problems of limited reinforcement effect, high cost, and single function. The hybrid woven fiber preforms can effectively solve the above problems, and can further meet the needs for high temperature resistance, thermal insulation, wave-absorbing and other functions through optimal selection of fiber and matrix.

Chinese utility model CN206173595U provides an aramid and fiber hybrid woven fabric, totally including four layers of structures, which are laid from top to bottom. The four layers of structures are: a glass fiber warp layer in the 0° direction, an aramid layer in the −45° direction, an aramid layer in the +45° direction and a surface felt in the bottom layer. The four layers of structures are laid sequentially, and stitched together with stitching threads to form an aramid fiber hybrid woven fabric. The present utility model patent mixes glass fiber and aramid fiber. The obtained hybrid woven fabric solves the problems of large rigidity, insufficient toughness, and poor impact resistance of a single Fiber Reinforced Plastics (FRP) composite material, and greatly increases the strength.

Chinese patent CN106868676B discloses a three-dimensional hybrid woven polyimide fiber-reinforced polyoxymethylene composite material and a preparation method thereof. The method prepares polyimide fiber and polyoxymethylene fiber into a covered yarn, and knits to obtain a three-dimensional hybrid woven fabric. The hybrid woven fabric is molded into a composite material. The method has a simple process and can prepare polyimide fiber-reinforced polyoxymethylene composite materials with different structures. The method ensures that the reinforced fiber obtains an effective length, is fully impregnated, and is evenly dispersed in the matrix The method has a very high amount of fiber addition, which maximizes the improving effect of fiber on the strength and modulus of polyoxymethylene.

Chinese patent CN110845826A discloses a method for preparing an impact-resistant hybrid fiber composite material based on natural silk, including the following steps: selecting a mulberry/tussah silk fabric and a carbon fiber/linen fiber fabric; knitting a hybrid woven fabric in the layer; pretreating a reinforcement fabric; preparing a hybrid fiber fabric-reinforced epoxy resin composite material by hand paste molding+hot press molding process and vacuum resin transfer molding process. The present disclosure has simple preparation process, high performance stability of final product, can improve the fracture toughness and impact toughness of carbon fiber composite materials, and is an impact-resistant composite material with use prospects.

At present, the fiber preforms studied are mostly including organic fibers, which have high flexibility, desirable textile performance, and simple process. There is a lack of high-performance products based on inorganic fiber hybrid woven preforms. In addition, the current research for hybrid woven fiber preform-reinforced composite materials focuses on the mechanical performances of resin-based composite materials. There are few studies on the high temperature resistance, ablation resistance, and wave-absorbing performances of ceramics, metal matrix and composite materials. Therefore, the development of a high-performance inorganic fiber-based hybrid woven fiber preform-reinforced composite material has important use values.

### SUMMARY

In order to solve the above problems, the present disclosure proposes a hybrid woven fiber preform-reinforced composite material, improves the composition and structure of the existing hybrid woven fiber preforms, thereby overcoming the shortcomings of existing materials and technologies.

In order to achieve the above objective, the present disclosure provides a hybrid woven fiber preform-reinforced composite material, including a fiber preform, a composite material interface and a matrix, where the fiber preform is a three-dimensional fabric woven by 2-5 types of fibers, the fiber preform has a fiber volume fraction of 35-65%, and a single fiber in the preform has a volume fraction of 5-60%; there are 2-5 layers of fiber clothes or felts in the preform, and each layer has a thickness of 0.5-50 mm; the layers form a three-dimensional overall structure by needle stitching, resin bonding, yarn drawing and curved shallow-crossing linking; the fibers are woven with a loom temple. A wave-transmitting composite material has an outer layer of quartz fiber, and an inner layer of high silica fiber or glass fiber; a wave-absorbing composite material has an outer layer of oxide fiber, a middle layer of silicon carbide fiber, and an inner layer of carbon fiber; a high-temperature structural material has an outer layer of silicon carbide fiber, and an inner layer of carbon fiber; a thermal insulation composite material below 1400° C. has an outer layer of silicon carbide fiber, a middle layer of carbon fiber and alumina fiber sequentially, and an inner layer of glass fiber; and a thermal prevention composite material above 1400° C. has an outer layer of carbon fiber, a middle layer of silicon carbide fiber, alumina fiber, and quartz fiber sequentially, and an inner layer of high silica fiber. The fiber clothes or felts include 1-3 types of fibers and 0-3 types of ceramic powders; the ceramic powders in fiber clothes or felts have a volume fraction of 0-30%, and a binder in the ceramic powder has a volume fraction of 0-5%; the ceramic powders are selected from the group consisting of silicon carbide, boron carbide, zirconium carbide, tantalum carbide, hafnium carbide, silicon nitride, boron nitride, silicon oxide, calcium oxide, yttrium oxide, zirconium oxide and aluminum oxide; the interface is selected from the group consisting of fullerene, graphene, pyrolytic carbon, silicon carbide, boron nitride and oxide; and the matrix material is selected from the group consisting of resin, light alloy, carbon and ceramic.

A preparation method of the hybrid woven fiber preform-reinforced composite material sequentially includes the following steps:

step 1, preparing a ceramic slurry, adjusting the Zeta potential of the slurry, and conducting ball milling to form a stable suspension;

step 2, impregnating a fiber bundle in the ceramic slurry, and pulling out, and maintaining the ceramic content in the fiber bundle;

step 3: winding, layering, and weaving a resulting fiber impregnated material into a two-dimensional cloth or a three-dimensional thin-walled structure, where the fibers are woven with a loom temple;

step 4. superimposing the two-dimensional cloth of different fiber types, or nesting the three-dimensional thin-walled structure of different fibers;

step 5, forming the layers into a preform of a three-dimensional overall structure by needle stitching, resin bonding, yarn drawing and curved shallow-crossing linking;

step 6, treating the preform at 300-1000° C. under vacuum or inert atmosphere;

step 7, preparing an interface for the preform; and

step 8, preparing a ceramic matrix by precursor impregnation pyrolysis to obtain a ceramic matrix-based composite material; preparing a resin matrix by resin transfer molding impregnation to obtain a resin matrix-based composite material; and preparing an alloy matrix by vacuum pressure impregnation to obtain a metal matrix-based composite material.

Compared with existing materials and technologies, the present disclosure has the following beneficial effects: (1) the present disclosure effectively solves the problem that the fiber is easy to produce broken filaments during the weaving process, and improves the weaveability of the fiber; (2) the hybrid woven fiber preform has desirable integrity and high bonding strength between layers, and the layers cannot be separated easily; (3) the composite material has short densification cycle, small fiber damage, and high structure strength, and realizes the integration of structure and function; (4) the multi-layer design on the structure reduces the amount of used high-priced fibers.

### DETAILED DESCRIPTION OF THE EMBODIMENTS

The present disclosure will be further explained in conjunction with specific examples. It should be understood that these examples are intended to illustrate the present disclosure rather than limit the scope of the present disclosure. Various equivalent modifications to the present disclosure made by those skilled in the art after reading the specification shall fall within the scope defined by the appended claims.

### EXAMPLE 1

A hybrid woven fiber preform-reinforced composite material included a fiber preform, a composite material interface and a matrix. The fiber preform was a three-dimensional fabric woven by 3 types of fibers, the fiber preform had a fiber volume fraction of 35%; there were 3 layers of fiber clothes in the preform; the layers formed a three-dimensional overall structure by yarn drawing; the fiber was woven with a loom temple during the weaving process. The fiber preform was a wave-absorbing composite material including: an outer layer of a glass fiber-based wave-transmitting layer, where the glass fiber had a volume fraction of 10% and a thickness of 5 mm, adopted a plain weave, and had an impedance of about 400Ω; a middle layer of a silicon carbide fiber-based loss layer, where the silicon carbide fiber had a volume fraction of 15% and a thickness of 3 mm, adopted a plain weave, and had a resistivity of 1-10 Ω·cm and a dielectric loss tangent value of 0.6; and an inner layer of a carbon fiber-based reflective layer, where the carbon fiber had a volume fraction of 10% and a thickness of 0.8 mm, adopted a satin weave, and had a resistivity of <0.5 Ω·cm; the impedance of each layer gradually decreased from the outside to the inside. The middle layer fiber cloth included silicon carbide fibers and silicon carbide ceramic powders, the ceramic powder in the fiber cloth had a volume fraction of 5%, and a binder in the ceramic powder had a volume fraction of 2%. The interface was a silica interface, and the matrix material was silica.

A preparation method of the hybrid woven fiber preform-reinforced composite material sequentially included the following steps:

step 1, a silicon carbide-based ceramic slurry was prepared, the Zeta potential of the slurry was adjusted to 50 mV, and ball milling was conducted to form a stable suspension;

step 2, a glass fiber bundle, a silicon carbide fiber bundle, and a carbon fiber bundle were impregnated in the ceramic slurry, and pulled out, and held at a temperature of 80° C. for 10 hours to dry while maintaining the ceramic content in the fiber bundle;

step 3, the glass fiber was woven into a two-dimensional plain weave, the silicon carbide fiber was woven into a two-dimensional plain weave, and the carbon fiber was woven into a two-dimensional 2/2 satin weave; the fibers were woven by a loom temple with a warp density of 6.0 threads/cm during the weaving process, where a silicon carbide ceramic powder was added when weaving the silicon carbide fiber cloth, and a surface density of the ceramic powder was 200 g/m²;

step 4, the obtained glass fiber cloth, silicon carbide fiber cloth, and carbon fiber cloth were superimposed sequentially;

step 5, the layers formed a preform of a three-dimensional overall structure by yarn drawing;

step 6, the preform was treated at 700° C. under vacuum and held for 1 hour;

step 7, vacuum impregnation was conducted with an external pressure of 0.5 MPa using silica sol as a precursor, a temperature at 90° C. was held for 12 hours to dehydrate and gel, and at 750° C. for 2 hours to prepare a silica interface;

step 8, a silicon carbide ceramic matrix was prepared by impregnation of silica sol with operation steps the same as those in step 7, and the impregnation was repeated for 12 cycles to obtain a ceramic matrix-based composite material.

The prepared composite material has a dielectric loss tangent value of 0.3-0.6 in the electromagnetic wave frequency band of 8.2-18.0 GHz. Table 1 shows specific parameters of the wave-absorbing performance and mechanical performance of the material. The highest reflectivity in the X-band can reach −20.1 dB, and the bending strength of the composite material can reach 301 MPa. Due to the excellent performance in wave-absorbing and bending strength, the material has important use value in the field of structural wave-absorbing.

TABLE 1
Wave-absorbing and mechanical performances of
hybrid woven fiber preform-reinforced silicon
carbide ceramic-based wave-absorbing material

| Rmin/dB | EAB/GHz | Bending strength/MPa |
|---|---|---|
| −20.1 | 5.9 | 301 |

### EXAMPLE 2

A hybrid woven fiber preform-reinforced composite material included a fiber preform, a composite material interface and a matrix. The fiber preform was a three-dimensional fabric woven by 2 types of fibers, the fiber preform had a fiber volume fraction of 45%; there were 2 layers of fiber clothes in the preform; the layers formed a three-dimensional overall structure by needle stitching; the fiber was woven with a loom temple during the weaving process. The fiber preform was a high-temperature structural material including: an outer layer of silicon carbide fiber, where the silicon carbide fiber had a volume fraction of 15% and a thickness of 8 mm; and an inner layer of carbon fiber, where the carbon fiber had a volume fraction of 20% and a thickness of 12 mm. The fiber cloth used included silicon carbide fiber, carbon fiber and 1 type of ceramic powder, where the ceramic powder in the fiber cloth had a volume fraction of 3%, and a binder in the ceramic powder had volume fraction of 1%. The used ceramic powder was silicon carbide, the interface was a pyrolytic carbon interface, and the matrix material was silicon carbide ceramic.

A preparation method of the hybrid woven fiber preform-reinforced composite material sequentially included the following steps:

step 1, a silicon carbide-based ceramic slurry was prepared, the Zeta potential of the slurry was adjusted to 60 mV, and ball milling was conducted to form a stable suspension;

step 2, a silicon carbide fiber bundle and a carbon fiber bundle were impregnated in the silicon carbide-based ceramic slurry, and pulled out, and held at a temperature of 70° C. for 12 hours to dry while maintaining the ceramic content in the fiber bundle;

step 3, the treated impregnated materials of carbon fiber and silicon carbide fiber were woven into a three-dimensional thin-walled structure, the fabric type was curved shallow-crossing linking; the fiber was woven with a loom temple, and silicon carbide-based ceramic powders were added during the weaving process, where the silicon carbide powder had a surface density of 225 g/m²;

step 4, the three-dimensional thin-walled structure of carbon fiber and silicon carbide fiber was nested to obtain a preform;

step 5, layers of the nested preform formed a preform of a three-dimensional overall structure by needle stitching;

step 6, the preform was treated at 1000° C. under vacuum and held for 1 hour;

step 7, a pyrolytic carbon interface was prepared by chemical vapor deposition with propylene as a gas source, and nitrogen as a dilution gas, where a total pressure of the system was 10 kPa, a P_{N2}/P_{C3H6} was 2:1, a deposition temperature was 900° C., and a deposition time was 2 hours;

step 8, a silicon carbide-based ceramic matrix was prepared by impregnation and pyrolysis of a precursor; a precursor solution was prepared with polycarbosilane as the precursor and xylene as a solvent; vacuum impregnation was conducted, pyrolysis was conducted at 1000° C. for 1 hour, and impregnation and pyrolysis was repeated for 11 cycles to obtain a ceramic matrix-based composite material.

The prepared composite material has a density lower than 2.6 g/cm³, desirable high temperature resistance up to 1200° C., bending strength at high temperature up to 280 MPa, and excellent oxidation resistance.

### EXAMPLE 3

A hybrid woven fiber preform-reinforced composite material included a fiber preform, a composite material interface and a matrix, where the fiber preform was a three-dimensional fabric woven by 5 types of fibers, the fiber preform had a fiber volume fraction of 65%; there were 5 layers of fiber clothes in the preform, and each layer had a thickness of 10-50 mm; the layers formed a three-dimensional overall structure by resin bonding; the fiber was woven with a loom temple during the weaving process. The fiber preform was a thermal prevention composite material above 1400° C. including: an outer layer of carbon fiber, where the carbon fibers had a volume fraction of 15% and a thickness of 10 mm; a middle layer including silicon carbide fiber, alumina fiber, and quartz fiber sequentially, where each fiber had a volume fraction of 10%, and a thickness of 8 mm; and an inner layer of high silica fiber, where the high silica fiber had a volume fraction of 20% and a thickness of 10 mm. The fiber cloth used included 1 type of fiber and 0 or 1 type of ceramic powder, where the ceramic powder in the fiber cloth had a volume fraction of 5%, and a binder in the ceramic powder had volume fraction of 3%, where the silicon carbide fiber layer was added with silicon nitride ceramic powder, the alumina fiber, quartz fiber, and high silica fiber were added with alumina ceramic powder; the interface was a silicon carbide interface, and the matrix material was ceramic.

A preparation method of the hybrid woven fiber preform-reinforced composite material sequentially included the following steps:

step 1, a silicon nitride ceramic slurry was prepared, the Zeta potential of the slurry was adjusted to 30 mV, and ball milling was conducted to form a stable suspension;

step 2, a carbon fiber bundle, a silicon carbide fiber bundle, an alumina fiber bundle, a quartz fiber bundle, and a high silica fiber bundle were impregnated in the ceramic slurry, and pulled out, and held at a temperature of 80° C. for 12 hours to dry while maintaining the ceramic content in the fiber bundle;

step 3, the obtained fiber impregnated materials were woven into three-dimensional thin-walled structures, and the fibers were woven by a loom temple during the weaving process, where the carbon fiber and silicon carbide fiber had a warp density of 6.0 threads/cm, silicon nitride ceramic powder was added during the weaving process, and the ceramic powder had a surface density of 200 g/m²; where the alumina fiber, quartz fiber, and high silica fiber had a warp density of 8.0 threads/cm, alumina powder was added during the weaving process, and the ceramic powder had a surface density of 180 g/m²;

step 4, the three-dimensional thin-walled structures of carbon fiber, silicon carbide fiber, alumina fiber, quartz fiber, and high silica fiber were sequentially nested;

step 5, the layers formed a preform of a three-dimensional overall structure by resin bonding;

step 6, the preform was treated at 700° C. under argon atmosphere and held for 1 hour;

step 7, a silicon carbide interface was prepared by chemical vapor deposition using tetrachlorosilane and methane as source materials at 500° C. for 1 hour;

step 8, for the carbon fiber of outer layer, a carbon matrix was prepared by chemical vapor deposition, and for the remaining layers, a silica matrix was prepared by impregnation with silica sol, where the selected silica sol had a particle size of 10-30 nm, and glass hollow microspheres or phenolic glass microspheres were added to the sol at a content of less than 10%; the matrix was held at 85° C. for 10 hours to dehydrate and gelate, and held at 750° C. for 1 hour to conduct heat treatment; the impregnation and pyrolysis was repeated for 10 cycles to obtain a ceramic matrix-based composite materials.

The prepared composite material can be used at a temperature up to 1400° C., has a thermal expansion coefficient of less than 4.5×10⁻⁶/° C., and a thermal conductivity of less than 40 W/m·K. The composite material has a desirable ablation resistance, and a temperature difference between inside and outside from the thermal insulation layer to the thermal prevention layer of higher than 700° C., which effectively realizes the integration of thermal prevention and thermal insulation.

The above described are merely specific implementations of the present disclosure, but the design concept of the present disclosure is not limited thereto. Any non-substantial changes made to the present disclosure based on the concept of the present disclosure should fall within the protection scope of the present disclosure. Any simple modification, equivalent change and modification made to the foregoing examples according to the technical essence of the present disclosure without departing from the content of the technical solution of the present disclosure shall fall within the scope of the technical solution of the present disclosure.

1. A hybrid woven fiber preform-reinforced composite material, comprising a fiber preform, a composite material interface and a matrix, wherein the fiber preform is a three-dimensional fabric woven by 2-5 types of fibers, the fiber preform has a fiber volume fraction of 35-65%, and a single fiber in the preform has a volume fraction of 5-60%; there are 2-5 layers of fiber clothes or felts in the preform, and each layer has a thickness of 0.5-50 mm; the layers form a three-dimensional overall structure by needle stitching, resin bonding, yarn drawing and curved shallow-crossing linking; the fibers are woven with a loom temple; wherein
a wave-transmitting composite material has an outer layer of quartz fiber, and an inner layer of high silica fiber or glass fiber;
a wave-absorbing composite material has an outer layer of oxide fiber, a middle layer of silicon carbide fiber, and an inner layer of carbon fiber;
a high-temperature structural material has an outer layer of silicon carbide fiber, and an inner layer of carbon fiber;
a thermal insulation composite material below 1400° C. has an outer layer of silicon carbide fiber, a middle layer of carbon fiber and alumina fiber sequentially, and an inner layer of glass fiber;
a thermal prevention composite material above 1400° C. has an outer layer of carbon fiber, a middle layer of silicon carbide fiber, alumina fiber, and quartz fiber sequentially, and an inner layer of high silica fiber; and
the fiber clothes or felts comprises 1-3 types of fibers and 0-3 types of ceramic powders; the ceramic powders in fiber clothes or felts have a volume fraction of 0-30%, and a binder in the ceramic powder has a volume fraction of 0-5%; the ceramic powders are selected from the group consisting of silicon carbide, boron carbide, zirconium carbide, tantalum carbide, hafnium carbide, silicon nitride, boron nitride, silicon oxide, calcium oxide, yttrium oxide, zirconium oxide and alumina; the interface is selected from the group consisting of fullerene, graphene, pyrolytic carbon, silicon carbide, boron nitride and oxide; and the matrix material is selected from the group consisting of resin, light alloy, carbon and ceramic.

2. A hybrid woven fiber preform-reinforced composite material, comprising a fiber preform, a composite material interface and a matrix, wherein the fiber preform is a three-dimensional fabric woven by 2-5 types of fibers, the fiber preform has a fiber volume fraction of 35-65%, and a single fiber in the preform has a volume fraction of 5% to 60%; there are 2-5 layers of fiber clothes or felts in the preform, and each layer has a thickness of 0.5-50 mm; the layers form a three-dimensional overall structure by needle stitching, resin bonding, yarn drawing and curved shallow-crossing linking; the fibers are woven with a loom temple into fiber clothes or belts; the fiber preform is selected from the group consisting of a wave-transmitting composite material, a wave-absorbing composite material, a high-temperature structural material, a thermal insulation composite material below 1400° C. and a thermal prevention composite material above 1400° C.; wherein
the wave-transmitting composite material has an outer layer of quartz fiber, and an inner layer of high silica fiber or glass fiber;
the wave-absorbing composite material has an outer layer of oxide fiber, a middle layer of silicon carbide fiber, and an inner layer of carbon fiber;
the high-temperature structural material has an outer layer of silicon carbide fiber, and an inner layer of carbon fiber;
the thermal insulation composite material below 1400° C. has an outer layer of silicon carbide fiber, a middle layer of carbon fiber and alumina fiber sequentially, and an inner layer of glass fiber; and
the thermal prevention composite material above 1400° C. has an outer layer of carbon fiber, a middle layer of silicon carbide fiber, alumina fiber, and quartz fiber sequentially, and an inner layer of high silica fiber; wherein
the fiber clothes or felts comprises 1-3 types of fibers and 0-3 types of ceramic powders; the ceramic powders in fiber clothes or felts have a volume fraction of 0-30%, and a binder in the ceramic powder has a volume fraction of 0-5%; the ceramic powders are selected from the group consisting of silicon carbide, boron carbide, zirconium carbide, tantalum carbide, hafnium carbide, silicon nitride, boron nitride, silicon oxide, calcium oxide, yttrium oxide, zirconium oxide and alumina;
the composite material interface is selected from the group consisting of fullerene, graphene, pyrolytic carbon, silicon carbide, boron nitride and oxide; and
the matrix is selected from the group consisting of resin, light alloy, carbon and ceramic matrices.

3. The composite material according to claim 1, wherein the ceramic powder has a surface density of 180-225 g/m².

4. The composite material according to claim 1, wherein the ceramic powder has a surface density of 180-225 g/m².

5. A preparation method of a hybrid woven fiber preform-reinforced composite material, sequentially comprising the following steps:
step 1, preparing a ceramic slurry, adjusting the Zeta potential of the slurry, and conducting ball milling to form a stable suspension;
step 2, impregnating a fiber bundle in the ceramic slurry, and pulling out, and maintaining the ceramic content in the fiber bundle;
step 3: winding, layering, and weaving a resulting fiber impregnated material into a two-dimensional cloth or a three-dimensional thin-walled structure, wherein the fibers are woven with a loom temple;
step 4. superimposing two-dimensional cloth of different fiber types, or nesting three-dimensional thin-walled structure of different fibers;
step 5, forming the layers into a preform of a three-dimensional overall structure by needle stitching, resin bonding, yarn drawing and curved shallow-crossing linking;
step 6, treating the preform at 300-1000° C. under vacuum or inert atmosphere;
step 7, preparing an interface for the preform; and
step 8, preparing a ceramic matrix by precursor impregnation pyrolysis to obtain a ceramic matrix-based composite material; preparing a resin matrix by resin transfer molding impregnation to obtain a resin matrix-based composite material; and preparing an alloy matrix by vacuum pressure impregnation to obtain a metal matrix-based composite material.

6. A preparation method of a hybrid woven fiber preform-reinforced composite material, sequentially comprising the following steps:
step 1, preparing a ceramic slurry, adjusting the Zeta potential of the slurry, and conducting ball milling to form a stable suspension;
step 2, impregnating the fiber bundle in the stable suspension, and pulling out, and maintaining the ceramic content in the fiber bundle to obtain a fiber impregnated material;
step 3: winding, layering, and weaving the fiber impregnated material into a two-dimensional cloth or a three-dimensional thin-walled structure, wherein the fiber impregnated material is woven by a loom temple during the weaving process;
step 4. superimposing the two-dimensional cloth of different fiber types, or nesting the three-dimensional thin-walled structure of different fibers;
step 5, forming the layers into a preform of a three-dimensional overall structure by needle stitching, resin bonding, yarn drawing or curved shallow-crossing linking;
step 6, treating the preform at 300-1000° C. under vacuum or inert atmosphere;
step 7, preparing an interface for the preform; and
step 8, preparing a ceramic matrix by precursor impregnation pyrolysis to obtain a ceramic matrix-based composite material; or
preparing a resin matrix by resin transfer molding impregnation to obtain a resin matrix-based composite material; or
preparing an alloy matrix by vacuum pressure impregnation to obtain a metal matrix-based composite material.

7. The preparation method according to claim 5, wherein the Zeta potential of the slurry in step 1 is adjusted to 30-60 mV.

8. The preparation method according to claim 6, wherein the Zeta potential of the slurry in step 1 is adjusted to 30-60 mV.

9. The preparation method according to claim 5, wherein the treatment in step 6 is conducted at 700-100° C.

10. The preparation method according to claim 6, wherein the treatment in step 6 is conducted at 700-100° C.

11. The preparation method according to claim 5, wherein the interface in step 7 is prepared by impregnation or vapor deposition.

12. The preparation method according to claim 6, wherein the interface in step 7 is prepared by impregnation or vapor deposition.

13. The preparation method according to claim 11, wherein the composite material interface pyrolytic carbon in step 7 is prepared by vapor deposition using propylene as a gas source and nitrogen as a dilution gas, at a total pressure of the system of 10 kPa and a P_{N2}/P_{C3H6} of 2:1, and a deposition temperature of 900° C. for 2 hours.

14. The preparation method according to claim 12, wherein the composite material interface pyrolytic carbon in step 7 is prepared by vapor deposition using propylene as a gas source and nitrogen as a dilution gas, at a total pressure of the system of 10 kPa and a P_{N2}/P_{C3H6} of 2:1, and a deposition temperature of 900° C. for 2 hours.
